(19) United States
(12) Patent Application Publication
(10) Pub. No.: US 2011/0221584 A1
(43) Pub. Date: Sep. 15, 2011

(54) System for Recording Collisions

(75) Inventors: Horst Plankenhorn, Villingen-Schwenningen (DE); Willibald Reitmeier, Hohenschambach (DE); Danny Schädlich, Neustadt (DE)

(73) Assignee: CONTINENTAL AUTOMOTIVE GMBH, Hannover (DE)

(21) Appl. No.: 13/119,887

(22) PCT Filed: Sep. 18, 2009
(86) PCT No.: PCT/EP2009/062111

§ 371 Date: May 12, 2011

(30) Foreign Application Priority Data
Sep. 19, 2008 (DE) 10 2008 048 163.7

(51) Int. Cl. B60Q 1/00

(52) U.S. Cl. 340/436

(57) ABSTRACT

A system for recording collisions in motor vehicles. The system includes a control unit that is connected to ultrasound sensors that can be disposed on or in the vehicle and is connected to acceleration sensors that can be disposed in the vehicle. Accident events are detected by the control unit based on acceleration values that are above a limit. Also, events below this limit are recorded when an approach to or contact with a collision object is determined by the ultrasound sensors.

### PRIORITY CLAIM

This is a U.S. national stage of Application No. PCT/EP2009/062111, filed on Sep. 18, 2009, which claims priority to German Application No: 10 2008 048 163.7, filed: Sep. 19, 2008, the contents of which are incorporated herein by reference.

### BACKGROUND OF THE INVENTION

1. Field of the Invention

The invention relates to a system and method for recording collisions in motor vehicles

2. Related Art

The prior art has disclosed systems for avoiding collisions. Document U.S. Pat. No. 7,102,496 B1 discloses a multi-sensor system that functions, inter alia, as a device for avoiding collisions.

Ultrasound systems are already known in the vehicle industry and are used, for example, in parking assistants for vehicles. The ultrasound parking sensors can be activated at low speeds, when the reverse gear is engaged and/or manually. At these low speeds, the sensors assume the function of proximity detectors or collision detectors.

The known devices have the disadvantage that during normal driving mode active collision detectors become active only starting from a certain impact force of a collision object on a vehicle. What are referred to as soft targets such as people are not perceived by the detectors owing to an excessively low impact force, and are therefore not detected.

### SUMMARY OF THE INVENTION

One embodiment of the invention is based on providing a collision detection system that detects possible collision objects early and already detects an accident event when there is a small impact force.

A system for recording collisions in vehicles according to one embodiment of the invention includes, a control unit that can be connected, on the one hand, to ultrasound sensors, which can be arranged on and/or in the vehicle and, on the other hand, to accelerometers, which can be arranged in the motor vehicle. Accident events can be detected by the control unit on the basis of acceleration values above a limiting value. According to one embodiment of the invention, even events below this limiting value are recorded when the ultrasound sensors detect an approach to or contact with a collision object.

According to one embodiment of the invention, the recorded data can be stored in a time frame of 45 seconds before and 20 seconds after the event, but preferably at least 28 seconds before and up to at least 15 seconds after the event. As a result, precise reconstruction of the entire collision process is ensured.

In order to detect the collision event, ultrasound sensors are advantageously mounted in the front region and/or in the side region of the vehicle. Approaches to the vehicle can therefore be detected from a wide range of directions.

In one preferred embodiment, the position of a collision object with respect to the vehicle is determined by averaging all of the ultrasound sensors. To do this, the travel distances between the collision object and the vehicle is recorded for all of the sensors and averaged over the number of said sensors. According to the invention, the direction of movement and/or the speed of a collision object before the impact with the vehicle can be determined in this way by the control unit. This permits predictive behavior. It is also possible for braking maneuvers or evasive maneuvers to be initiated in good time.

Critical driving situations can advantageously be stored manually. It is therefore possible for a vehicle occupant to define individually whether a situation is to be considered to be an accident event and recorded. The setting of the recording function on the control unit signals to the system the particular importance after the event, and causes the memory manager to keep the respective event longer in the memory and/or to move it into a permanent memory.

According to one embodiment of the invention, in the event of a serious accident the system makes available a signal for emergency signaling, which signal can be transmitted directly to an emergency center using suitable communication media. This emergency call can be triggered automatically, with the result that, in the event of injury to the vehicle occupant, help is called automatically.

In one preferred embodiment, the system can be integrated into a tachograph of the vehicle. The vehicle therefore does not have any additional device that could quickly make the dashboard overcomplicated. However, it is also possible to use the system solely as an accident data recorder.

After detection of a possible collision object, the control unit can preferably initiate automated actions such as steering processes and/or braking processes, and/or warning signals can preferably be output to the driver. Said warning signals can be individually acoustic or visual and adapted for specific applications. This is particularly advantageous if the distance from the collision object is too small in order to still be able to react with the human reaction capability, or if obstacles can easily be overlooked while driving at night.

According to one embodiment of the invention, the control unit continuously records data and deletes or overwrites said data again subsequently if no event has been registered. If the vehicle impacts against an obstacle at a high speed, the acceleration sensors register strong negative accelerations above a specific threshold value. If the threshold value is exceeded, an accident is recorded and the last seconds in the given time period are not deleted in the control unit. At the same time, the data of the seconds after the accident are retained. The data remains stored in the control unit and is moved into the permanent memory. If an accident occurs with a soft target, the ultrasound sensors are triggered. The sensors are active during the entire driving process and can record accidents even at low collision values.

### BRIEF DESCRIPTION OF DRAWINGS

The system for recording collisions will now be explained in more detail on the basis of a number of exemplary embodiments, in which:

FIG. 1 is a schematic illustration of the recording of the collision; and

FIG. 2 is a schematic illustration of a vehicle with a system according to the invention.

### DETAILED DESCRIPTION OF DRAWINGS

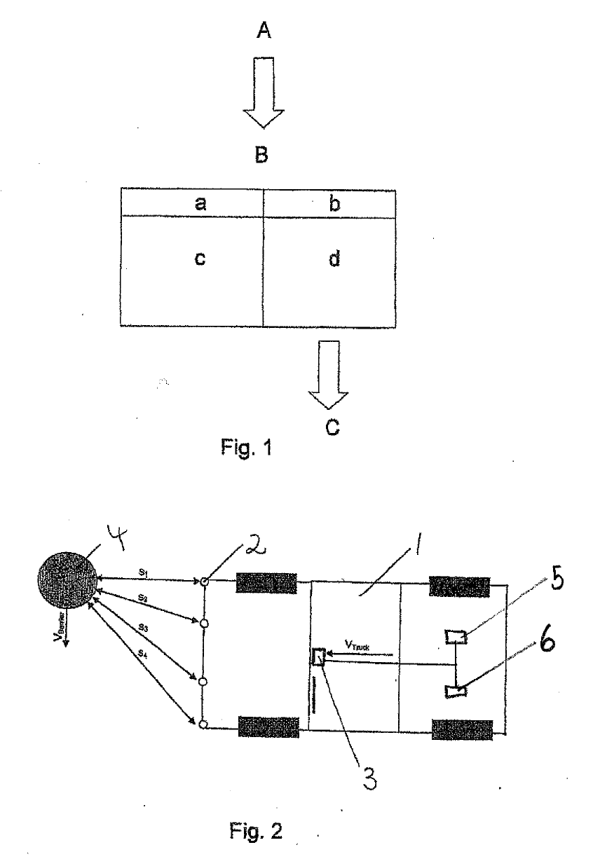

FIG. 1 shows the recording of a collision. At the point A, the vehicle 1 impacts against an obstacle 4 at a high speed. The acceleration sensors 5 register a strong negative acceleration above a defined threshold value (B). If the acceleration sensors 5 (a) exceed a threshold value, an accident is registered (c) and the last seconds of the recording are not deleted, but rather stored in the system. If the threshold value is not exceeded (b) by an excessively low impact force, such as for example when a collision occurs with a soft target, in conventional systems no accident is registered (d) and the data is deleted from the system. At this point (C), the present system for recording collisions in motor vehicles comes into play. The data are retained. The detection of a collision object 4 is carried out by ultrasound sensors 2, which have a low threshold value. Alternatively, the system can be set manually.

FIG. 2 schematically illustrates a vehicle 1 with integrated sensors 2. The system has a controller 3 which is connected, on the one hand, to ultrasound sensors 2, which can be arranged on and/or in the vehicle 1, and to accelerometers 5 which can be arranged in the motor vehicle. Accident events can be detected by the control unit 3 on the basis of acceleration values above a limiting value. Events below this limiting value are recorded when the ultrasound sensors 2 detect an approach to or contact with a collision object 4.

The data are stored in a time period of 28 seconds before and up to 15 seconds after the event.

The ultrasound sensors 2 are mounted in the front region and/or in the side region of the vehicle 1. If an obstacle is detected, each ultrasound sensor 2 picks up a value above which the respective distances s₁, s₂, s₃ and s₄ of the collision object 4 is determined. On this basis, the control unit 3 determines the change in position and the speed v_{Barrier} before the impact with the vehicle 1. This is done by averaging over all the ultrasound sensors 2. In this context, the speed of the collision object 4 v_{Barrier} and the speed of the vehicle 1 v_{Truck} are taken into account. On the basis of these calculations, driving situations which are determined as being critical can be stored manually or in an automated fashion.

The control unit 3 continuously records data. If no event is detected, the data is deleted and new data is recorded or the data are overwritten. After a collision has been detected, the data continues to be stored in the control unit 3 and is moved into a permanent memory 6.

If a possible collision object 4 is detected by the ultrasound sensors 2 and the situation is categorized as critical by the system, warning signals are output to the driver in a visual or acoustic form. One possibility is a buzzing tone which becomes continuously louder and/or softer as a function of the distance between the collision object 4 and the vehicle 1. The system initiates automated actions such as steering processes and/or braking processes as necessary.

If there is an impact between a collision object 4 and the vehicle 1, an automatic emergency call is triggered.

The system can be used as an accident data recorder. It is also possible for said system to be integrated into existing devices in the vehicle 1, such as tachographs, or to be used as a stand-alone system.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-15. (canceled)

16. A system for recording collisions in a vehicle, comprising:
a plurality of ultrasound sensors arranged at least one of on and in the vehicle;
at least one accelerometer arranged in the vehicle; and
a control unit arranged in the vehicle, and connected to the plural ultrasound sensor and the at least one accelerometer.
wherein accident events are detected by the control unit based at least in part on an acceleration value above a limiting value, and even events below the limiting value are recorded when the plural ultrasound sensors detect at least one of an approach to and contact with a collision object.

17. The system as claimed in claim 16, wherein data in a time window from at least 28 seconds before to at least 15 seconds after the accident event are stored.

18. The system as claimed in claim 16, wherein the plural ultrasound sensors are mounted in one or more of a front region and a side region of the vehicle.

19. The system as claimed in claim 16, wherein a position of a collision object with respect to the vehicle is determined by averaging data from the plural ultrasound sensors.

20. The system as claimed in claim 16, wherein the control unit is configured to determine at least one of a direction of movement and a speed of a collision object before impact with the vehicle.

21. The system as claimed in claim 16, wherein a critical driving situation can be stored manually.

22. The system as claimed in claim 16, wherein the control unit is configured to trigger an automatic emergency call.

23. The system as claimed in claim 16, wherein the control unit is at least a portion of a tachograph.

24. The system as claimed in claim 16, wherein the system is only an accident data recorder.

25. A method for operating a collision recording system in a vehicle, wherein the system has a control unit connected to a plurality of ultrasound sensors and at least one accelerometer, the method comprising:
detecting an acceleration value;
comparing the detected acceleration value to an acceleration limiting value, wherein accident events are detected based on the acceleration value above the acceleration limiting value; and
recording events below the acceleration limiting value when the plural ultrasound sensors indicate a contact.

26. The method as claimed in claim 25, further comprising initiating by the control unit at least one of an automated steering processes and an automated braking processes after a detection of a possible collision object.

27. The method as claimed in claim 25, further comprising outputting a warning signal is output after the detection of a possible collision object.

28. The method as claimed in claim 25, wherein after a collision automatic emergency signaling occurs.

29. The method as claimed in claim 25, wherein the control unit continuously records data and deletes the data.

30. The method as claimed in claim 25, wherein after a threshold value has been exceeded, a last data in the control unit remains stored and is moved to a permanent memory.

31. The system as claimed in claim 19, wherein the control unit is configured to determine at least one of a direction of movement and a speed of a collision object before impact with the vehicle.

32. The method as claimed in claim 29, wherein after a threshold value has been exceeded, a last data in the control unit remains stored and is moved to a permanent memory.

33. The method as claimed in claim 29, wherein the control unit continuously records data in a time window from at least 28 seconds before to at least 15 seconds after the accident event.
